(19) United States
(12) Patent Application Publication
(10) Pub. No.: US 2006/0260181 A1
(43) Pub. Date: Nov. 23, 2006

(54) FISHING WEIGHT

(76) Inventors: Kenneth E. Enos, Grand Rapids, MI (US); Todd M. Petipren, Scottville, MI (US)

Correspondence Address: DOBRUSIN & THENNISCH PC, 29 W LAWRENCE ST, SUITE 210, PONTIAC, MI, 48326, US

(21) Appl. No.: 11/419,250

(22) Filed: May 19, 2006

Related U.S. Application Data
(60) Provisional application No. 60/682,728, filed on May 19, 2005.

(51) Int. Cl. A01K 95/00; A01K 91/08

(52) U.S. Cl. 43/43.13; 43/42.36

(57) ABSTRACT

A fishing weight, and more particularly a diving fishing weight, is disclosed. The fishing weight is generally designed to provide, in certain circumstances, at least some degree of lesser resistance to pull from, for instance, a fishing line. In turn, the weight can provide better conditions for pulling a fish, pulling the weight or both.

### CLAIM OF PRIORITY

This application claims the benefit of the filing date of U.S. Provisional Application No. 60/682,728, filed May 19, 2005.

### TECHNICAL FIELD

The present invention relates to the field of fishing weights and more particularly to the field of diving fishing weights.

### BACKGROUND OF THE INVENTION

The fishing industry has employed weights for many years and various different weights have been designed. One particular type of weight is a diving weight that, in use, has a tendency to, at least to some degree, move away from the surface of water as it is pulled through the water. Such diving weights have been found useful for aiding in moving fishing lures to desired depths within bodies of water. Previous designs for such weights, however, have exhibited drawbacks. As one example, some prior diving weights have been difficult and/or expensive to manufacture. As another example, some prior diving weights provide undesirable degrees of resistance to being brought to the surface of a body of water during the actual event of catching a fish or otherwise. The present invention therefore provides a diving weight that overcomes one or both of the aforementioned drawbacks and/or other drawbacks that will become evident upon reading the detailed description below.

### SUMMARY OF THE INVENTION

Accordingly, a fishing weight is disclosed. The fishing weight includes a body and a release. The body typically includes a weighted mass. The weight is designed to dive below the surface of water as it is pulled through the water. The body of the weight can have a shape, a weight distribution or both for assisting the weight in diving. The weight can also have an attachment mechanism by which the weight attaches to a fishing line for assisting the weight in diving. The release can be directly or indirectly connected to the body of the weight and the release is preferably designed to cause, upon a strike of a fish, disassembly of the weight, release of the weighted mass from the fishing weight or both.

### BRIEF DESCRIPTION OF THE DRAWINGS

The features and inventive aspects of the present invention will become more apparent upon reading the following detailed description, claims, and drawings, of which the following is a brief description:

FIG. 1 is a blown up perspective view of an exemplary fishing weight according to an aspect of the present invention.

FIG. 2 is a blown up bottom view of the exemplary fishing weight of FIG. 1.

FIG. 3 is a blown up side view of the exemplary fishing weight of FIGS. 1 and 2 being applied to a fishing line.

FIG. 4 is an assembled view of the exemplary fishing weight of FIGS. 1 and 2 after application of the fishing weight to the fishing line.

FIG. 5 is an assembled perspective view of another exemplary fishing weight in accordance with the present invention.

FIG. 6 is a perspective view of an exemplary release member in accordance with an aspect of the present invention.

FIG. 7 is a perspective view of the exemplary weight of FIG. 5 after release of a secondary release in accordance with an aspect of the present invention.

### DETAILED DESCRIPTION OF THE PREFERRED EMBODIMENT

The present invention is predicated upon the provision of an improved fishing weight. The fishing weight will include one or more of the following features:
1) A body having a shape and or weight distribution for causing the weight to dive downwardly away from the surface of the water;
2) a release that causes, upon the strike of a fish, disassembly of the fishing weight and/or release of a mass from the fishing weight;
3) a member for guiding lateral motion of the fishing weight under water; and/or
4) a secondary release that can assist in easing the amount of energy needed for pulling the weight toward the surface of the water.

Generally, it is contemplated that the fishing weight may be a singular integrated component. Alternatively, the fishing weight may be comprised of multiple components that can be assembled and disassembled relative to each other.

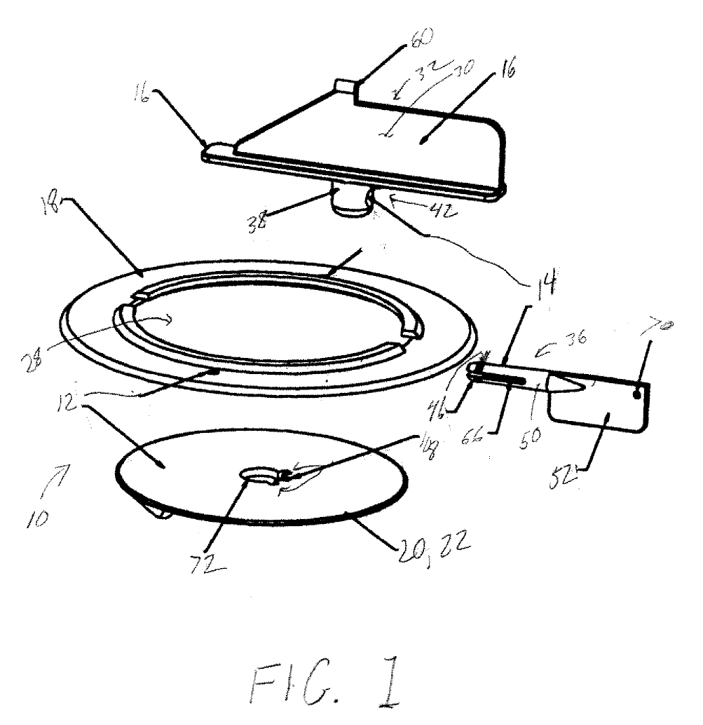

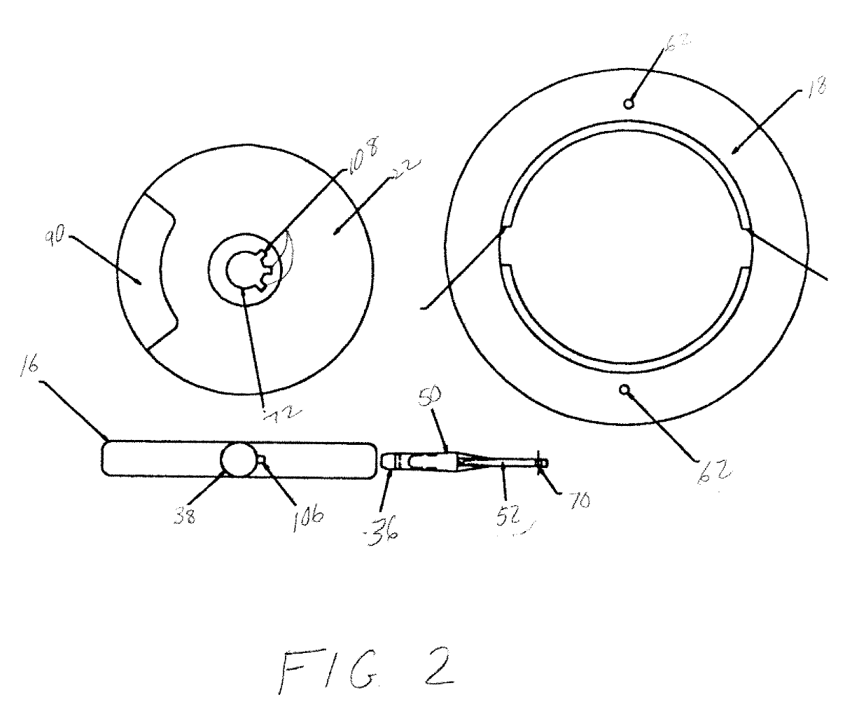

Referring to FIGS. 1 and 2, there is illustrated an exemplary fishing weight 10 according to one exemplary embodiment of the present invention. The illustrated fishing weight 10 includes a body 12, a release 14 and a guide member 16.

The body of the fishing weight may be formed of a single component or multiple components, which may be releasably or substantially permanently assembled together. In the embodiment illustrated, the body 12 of the fishing weight 10 includes an optional outer disk 18 and a main disc 20, which also serves as a weighted mass 22 for the fishing weight 10. As can be seen, the main disc 20 is receivable within or adjacent a central opening 28 (e.g., through-hole or cavity) of the outer disk 18 and the central opening 28 extends into and/or through the outer disk 18.

As will be further understood below, in alternative embodiments, the mass 22 may be part of the body 12 of the fishing weight 10 or may be separate from the body of the fishing weight 10. As one possible alternative example, the annular disc 18 could be replaced by a more continuous disc that has a mass releasably attached to a lower surface of the disc. Moreover, it will be understood that the body of the fishing weight and the weighted mass of the fishing weight could be configured to have a variety of alternative shapes and sizes within the scope of the present invention.

It is contemplated that the guide member may be formed in a variety of shapes or configurations within the scope of the present invention, unless otherwise specifically recited. As such, the guide member may be substantially planar or may be contoured. The guide member 16 illustrated is generally elongated and planar with two side walls 30, 32 separated by a thickness of the guide member 16.

The release of the fishing weight, like the other components of the fishing weight, could also be provided in a variety of shape and configurations within the scope of the present invention. For example, releasable fasteners such a clip, members with tear seams, rubber bands or others may be employed as the release of the present invention unless otherwise stated.

In the particular embodiment illustrated, the release 14 includes a pin 36 and a receiving member 38. The receiving member 38 illustrated is a generally cylindrical receiving member 38 that extends outwardly from a bottom area of the guide member 16. The receiving member 38 is shown as having an opening 42 (e.g., a cavity or through-hole) suitable for receipt of the pin 36. The pin 36 is illustrated as having two coextensive legs 46 extending from a base portion 50 of the pin 36. The pin 36 is also shown to have a planar member 52, which as further described below can act as a rudder or stabilizer for the weight 10.

The components of the fishing weight including the body, the weighted mass, the release, the guide member, the receiving member, the pin and the others as further discussed below can be formed of a variety of materials including metals, polymeric materials (e.g., plastics), fibrous materials, combinations thereof or the like. As such, each of the components can be shaped using metal shaping techniques such as stamping or bending or shaped using polymeric or plastic shaping techniques such as molding (e.g., injection molding, blow molding, compression molding or the like) or other shaping techniques.

In the illustrated embodiment, the outer annular disk 18, the guide member 16 and the release 14 are all formed of plastic such as a thermoplastic (e.g., a polyamide, a polyethylene, combinations thereof or the like). The weighted mass 22 or inner disc 20 illustrated is partially or substantially entirely formed of material that at least includes a metal (e.g., lead) or other material that is relatively dense. Preferably the density of the material is greater than about 0.15 lb/in³, more preferably greater than about 0.25 lb/in³ and even more preferably greater than about 0.35 lb/in³. The total weight of the weighted mass is typically at least about 0.2 lbs., although it could be less, more typically at least about 0.35 lbs and still more typically at least about 0.44 lbs. The total weight of the weighted mass is typically less that about 1.0 lbs., although it could be more, more typically less than about 0.70 lbs. and even more typically less than about 0.58 lbs.

In one preferred embodiment, the fishing weight includes a weighted mass (which may be a singular member or may include multiple members) that has a mass or weight that is at least 150%, 200%, 400% or more of the mass or weight of at least the guide member and the release combined or 150%, 200%, 400% or more the mass or weight of all of the remaining components of the fishing weight. For purposes of clarity and example, it should be understood that 150%, 200% and 400% of mass or weight of 10 grams is respectively 15 grams, 20 grams and 40 grams.

Assembly

Assembly or attachment of the fishing weight to a fishing line typically involves attachment of the fishing line to the release and/or attachment of the weighted mass to the release and/or fishing wherein one or both of the attachments is releasable. Generally, the assembly of the fishing weight will depend upon the configuration and parts used for the fishing weight. As one example, if the fishing weight is entirely or substantially entirely formed of a singular material, the fishing weight may not require substantial assembly and may be suitable for attachment to a fishing line (e.g., via a clip or other release) upon formation of the fishing weight. Thus, it should be understood that the following detailed discussion of the assembly of the fishing weight 10 of FIGS. 1 and 2 to a fishing line is for exemplary purposes and that, depending upon the type of release used for the fishing weight or depending upon other variables, assembly of the fishing weight 10 could be different while still remaining within the scope of the present invention.

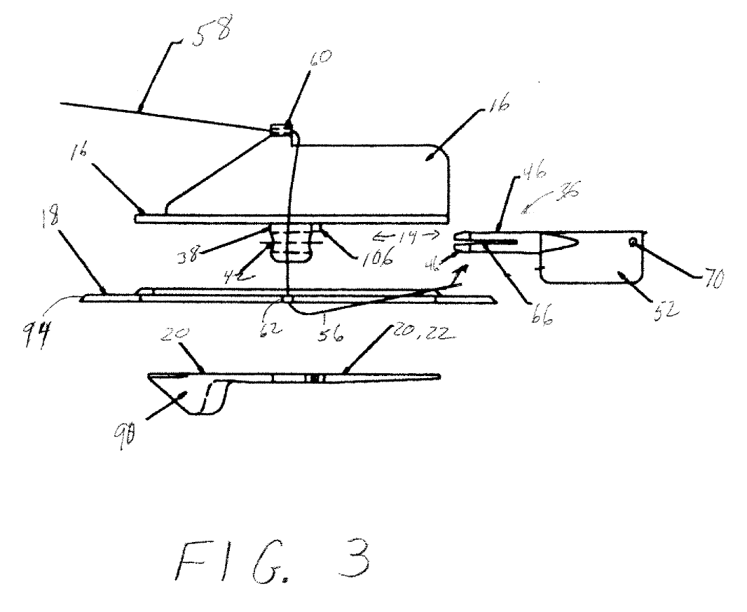

With reference to FIG. 3 and 4, the fishing weight 10 is illustrated during and upon assembly thereof to a fishing line 58. In FIGS. 3 and 4, the line 58 is extended into and through an opening 60 (e.g., a through-hole) in an upper portion of the guide member 16 and into and through an opening 62 (e.g., a through-hole) in the annular disc 18. The line 58 is then located in an opening 66 (e.g., a cavity) between the legs 46 of the pin 36 and may optionally be wrapped one or more times about the pin 36. The line 58 is lastly preferably extended through an opening 70 (e.g., a through-hole) in the planar member 52.

To set the release 14 and complete assembly, the receiving member 38 is extended into and through an opening 72 (e.g., through-hole) in the body 12 of the weight 10 and more particularly in the weighted mass 22. The guide member 16 and the weight mass 22 are both received in or adjacent the openings 28 (e.g., cavities) formed in the annular disc 18. Then, the pin 36 is inserted into the opening 42 of the receiving member 38, thereby lodging the body 12 including the weight mass 22 and the annular disc 18 at least partially between the pin 36 and the guide member 16. In the embodiment illustrated, upon insertion, the pin 36 interferingly engages the receiving member 38 to releasably fasten the pin 36 to the receiving member 38.

Before, after or during assembly of the fishing weight to the fishing line, depending upon the configuration of the fishing weight or other factors, a fish hooking device is typically attached (e.g., tied) to a distal end of the fishing line. In the embodiment shown, the fishing line is tied to a fish hooking device 80, which is shown as a single fish hook. However, it will be understood that the fishing weight may be employed in conjunction with several types of fish hooking devices including, without limitation, lures (e.g., spoons, plugs or the like), live bait (e.g., worms, minnows, leaches or the like), flies, rubber worms, combinations thereof or the like all of which typically include or are use in conjunction with hooks.

Operation

Generally, the body of the fishing weight of the present invention will have a shape and/or a weight distribution that, optionally in conjunction with forces placed upon the fishing weight by a fishing line, causes the fishing weight to dive downwardly away from the surface of a body of water. As an example, it is contemplated that the fishing weight may have a surface or wall that is downwardly skew relative to the path of travel of the fishing weight. As an additional or alternative example, the body of the fishing weight could have a weight distribution that places a greater amount (e.g., greater than 50%, 55%, 60%, 70%, 80% or even more) of the mass or weight of the total fishing weight in a forward portion (i.e. forward at least 50% of the total volume of the fishing weight) of the fishing weight.

In the exemplary embodiment illustrated in FIG. 4, a dashed line 84 has been employed for dividing the fishing weight 10 into a forward portion 86 and a rearward portion 88. As can be seen, the weighted mass 22 includes a higher volume and/or weight portion 90 that is designed to be located in the forward portion of the weight 10 upon assembly thereof for assisting the diving of the weight 10. This weighted portion 90 assists in creating the aforementioned weight distribution. The body 12 or annular disc 18 of the fishing weight 10 has a surface or wall 94 that is skew relative to the expected path of travel 100 of the fishing weight 10 for assisting the diving of the weight 10. It can also be seen that, by virtue of the line 58 extending through the opening 60 of guide member 16 and then attaching to the pin 36 below the opening 60, pulling of the fishing weight 10 through the water will assist the fishing weight 10 in angling and/or diving downwardly.

Upon placement and pulling of the fishing weight in the water, the fishing weight will dive downwardly through the water thereby diving the fish hooking device downwardly as it trails the weight. Advantageously, the design of the fishing weight can be such that the fishing weight can be configured to dive to a particular depth or range of depths, which may be dependent upon the amount of line between the fishing weight and the surface of the water and other factors (e.g., speed at which the fishing weight is being pulled through the water by a trolling boat or the reeling in of the fishing line). For the exemplary embodiment illustrated, it is contemplated that multiple different weighted masses such as the weighted mass 22 illustrated that have been modified to have varied different higher volume and/or weight portions similar to but different from as the portion 90 illustrated may be employed in conjunction with the other components of the weight 10 to make the weight dive to different predetermined depths or depth ranges.

Additionally, the fishing weight may include a guide member that provides the fishing weight with the tendency to move laterally underwater. Such a guide member will typically provide a surface or wall that, underwater, is or becomes skew relative to the fishing line pulling the weight. In the embodiment illustrated, the receiving member 38, the guide member 16 or both have a protrusion 106 extending therefrom. Upon assembly of the weight, the protrusion is typically located within one of a plurality of openings 108 (e.g., cavities) which are extensions of the main opening 72 of the weighted mass 22. Depending upon the opening 108 into which the protrusion is placed, the fishing weight 10 will either have a tendency to move laterally right or left relative to the fishing line 58 or travel a relatively straight line behind the fishing line due to the different positioning of the guide member 16 relative to the fishing line.

In the event of a fish striking the fish hooking device, it is preferable for the fishing weight to transform to a non-diving configuration and/or for the fishing weight to release the weighted mass or another portion of the fishing weight. In the embodiment shown, a fish strike will typically cause the pin 36 to be pulled out of or released from the opening 42 of the receiving member 38. In that event, the weighted mass 22 is released from the rest of the components (i.e., the guide member 16, the annular disc 18, and the pin 36 and rudder 52) of the fishing weight 10 and released from the fishing line 58. However, the remaining components (i.e., the guide member 16, the the annular disc 18, and the pin 36 and rudder 52) remain connected to the fishing line 58 since the line 58 extends into and/or through enclosed openings 60, 62, 70 of those components. Of course, as an option, the weighted mass 22 could having an opening (e.g. a through-hole) through which the line 58 could be extended such that the weight mass 22 is also maintained on the line 58 in the event of fish striking the fish hooking device 80. Advantageously, this reconfiguration and/or loss of weight mass provides a fisherman with a more desirable fish fighting experience.

Additional or Alternative Features and/or Embodiments

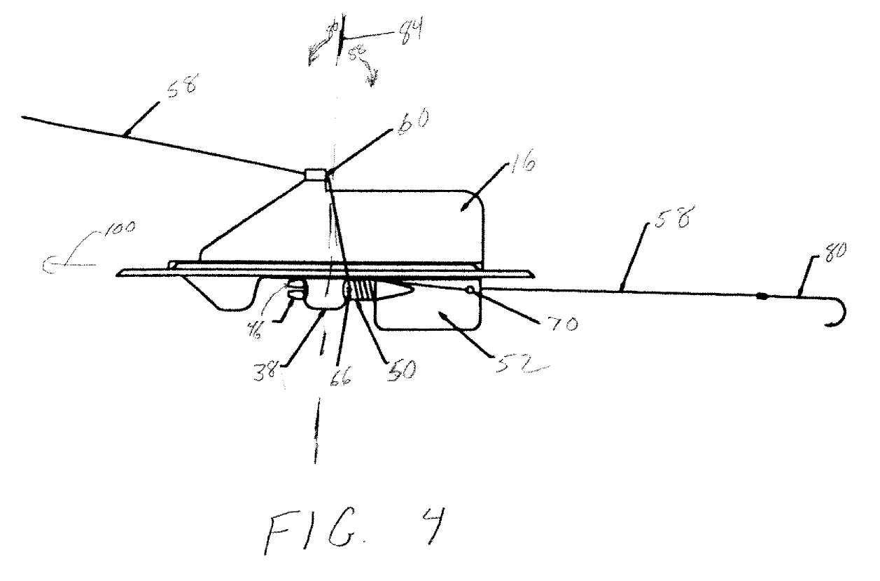

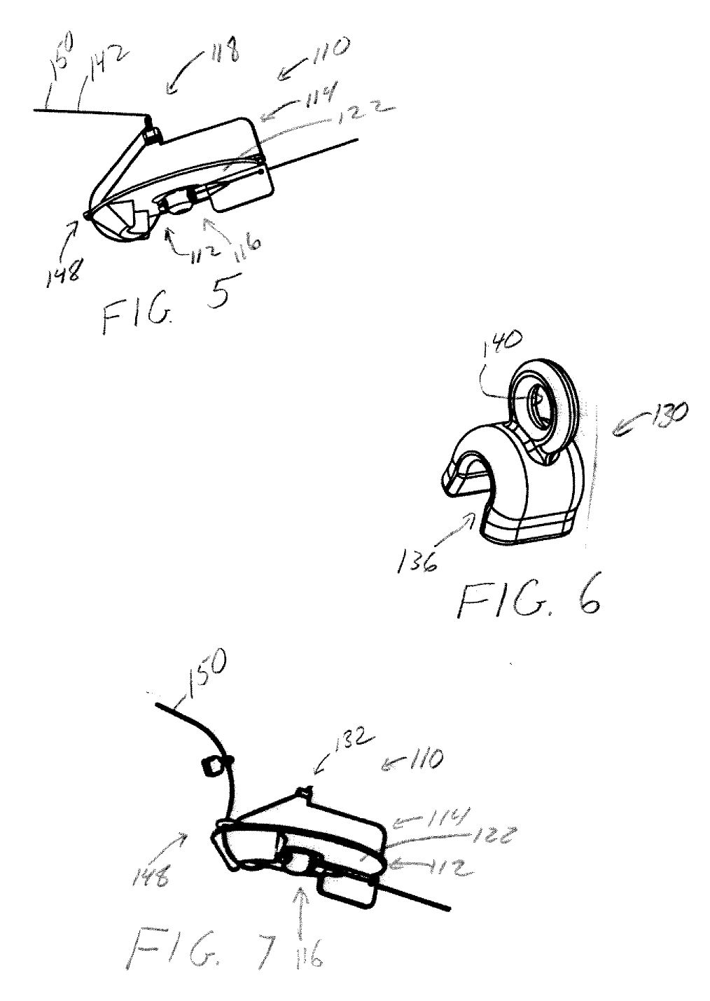

FIGS. 5-7 illustrate an alternative or additional embodiment of a fishing weight 110 according to the present invention. It should be understood that the fishing weight of FIGS. 5-7 is substantially similar or identical to the fishing weight of FIGS. 1-4 with certain exceptions. As such, discussions of components, assembly and operation of the fishing weight of FIGS. 1-4 are also used to describe those features of the fishing weight of FIGS. 5-7 where applicable.

The fishing weight 110 of FIGS. 5-7 includes a body 112, a guide member 114, a primary release 116 and a secondary release 118. The body 112 includes only a weighted mass 122, although it could include other components as well.

The secondary release is typically configured for, upon application of significant force to a fishing line (e.g., from a fishing line source such as a fishing pole and/or reel), release of at least a portion of the secondary release from the rest of the fishing weight such that the fishing weight has a lesser tendency to dive. Thus, an individual or otherwise can apply significant force to the fishing weight by pulling on the fishing line (e.g., typically pulling on the line between the fishing line source and the fishing weight) such that the secondary release releases and changes the force diving dynamic of the fishing weight.

In FIGS. 5-7, the secondary release 118 includes a secondary release receiving member 130 and a secondary release protrusion member 132. As can be seen, the receiving member 130 includes an opening 136 shown as a cavity suitable for receipt of the protrusion member 132. As shown, the protrusion member 132 is at an upper portion of the guide member 114, however, it may be elsewhere located if desired. The secondary release 118 also includes an opening 140 (e.g., a through-hole) for receiving fishing line 142.

As can be seen, the fishing line 142 (e.g., from a fishing line source) can extend through the opening 140 in the secondary release 118 then through an opening 144 in a forward portion 148 of the fishing weight 110 shown in the exemplary embodiment as through-hole in the forward portion 148 of the guide member 114. The line 142 can then be engaged by the primary release 116 as was described in relation to the fishing weight of FIGS. 1-4.

In operation, the fishing weight 110 tends to dive since the source line 150 (i.e., the portion of the line 142 between the weight 110 and the source of the line 142) pulls on the release 118 at an upward region of the fishing weight 110 assisting in providing for the tendency of the fishing weight to dive. Then, if it becomes desirable to bring the weight 110 to the surface of the water, a significant force can be applied to the source line 142 releasing the secondary release 118 without releasing the primary release 116. Thus, the source line 142 pulls at the forward portion 148 of the weight 110 and the tendency of the weight 110 to dive is at least significantly lessened.

In addition to the above, it is contemplated that the fishing weight may be without a weighted mass. In such an embodiment, the weighted mass of the above embodiment could be replace by one of more alternative lighter weight pieces that, upon the strike of a fish, disassemble from the other components of the fishing weight and either are release as with the weighted mass or remain on the line.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A fishing weight, comprising:
a body of the weight that includes a weighted mass; and
a release connected to the body of the weight that causes, upon a strike of a fish, disassembly of the weight, release of the weighted mass from the fishing weight or both;
wherein the weight is configured to dive in water as it is pulled through the water.

2. A fishing weight as in claim 1 further comprising a member for guiding lateral motion of the fishing weight underwater.

3. A fishing weight as in claim 1 wherein the weighted mass of the fishing weight is at least 50% of the total weight of the fishing weight.

4. A fishing weight as in claim 1 wherein the mass of the fishing weight is at least 80% of the total weight of the fishing weight.

5. A fishing weight as in claim 1 wherein the fishing weight is one singular integrated component.

6. A fishing weight as in claim 1 wherein the fishing weight includes multiple components releasably assembled to each other.

7. A fishing weight as in claim 1 wherein the fishing weight includes a secondary release that, upon release causes the fishing weight to have less of a tendency to dive.

8. A fishing weight as in claim 1 wherein the weighted mass is formed of a material having a density of at least about 0.25 lb/in³ and a total weight of at least 0.35 lbs. and less than about 0.7 lbs.

9. A fishing weight, comprising:
a body of the weight that includes a weighted mass, the body having a shape or weight distribution for causing the weight to dive downwardly away from a surface of water;
a release connected to the body of the weight that causes, upon a strike of a fish, disassembly of the weight and release of a weighted mass from the fishing weight wherein the release configured for attachment to fishing line such that the release remains attached to the fishing line after release of the weighted mass.

10. A fishing weight as in claim 9 further comprising a member for guiding lateral motion of the fishing weight underwater.

11. A fishing weight as in claim 9 wherein the weighted mass of the fishing weight is at least 50% of the total weight of the fishing weight.

12. A fishing weight as in claim 9 wherein the mass of the fishing weight is at least 80% of the total weight of the fishing weight.

13. A fishing weight as in claim 9 wherein the fishing weight is one singular integrated component.

14. A fishing weight as in claims 9 wherein the fishing weight includes multiple components releasably assembled to each other.

15. A fishing weight as in claim 9 wherein the weighted mass is formed of a material having a density of at least about 0.25 lb/in³ and a total weight of at least 0.35 lbs. and less than about 0.7 lbs.

16. A fishing weight, comprising:
a body of the weight that includes a weighted mass, the body having a shape, a weight distribution or both for causing the weight to dive downwardly away from the surface of the water;
a release connected to the body of the weight, the release including a receiving member and a pin receivable in the receiving member wherein, upon strike of a fish, the pin is pulled from the receiving member and allows release of the weighted mass;
a guide member connected to the receiving member; and
a secondary release configured for, upon application of significant force from a fishing line source, release of at least a portion of the secondary release from the rest of the weight such that the weight has a lesser tendency to dive;
wherein each of the release, the guide member and the secondary release including an opening configured for receipt of fishing line to allow the release, the guide member and the second release to remain attached to the fishing line after release of the weighted mass.

17. A fishing weight as in claim 16 wherein the mass of the fishing weight is at least 80% of the total weight of the fishing weight.

18. A fishing weight as in claim 17 wherein the weighted mass is formed of a material having a density of at least about 0.25 lb/in³ and a total weight of at least 0.35 lbs. and less than about 0.7 lbs.

19. A fishing weight as in claim 18 wherein the fishing weight includes multiple components releasably assembled to each other.

20. A fishing weight as in claim 19 further comprising a line attachment mechanism for causing the weight to dive downwardly away from the surface of the water.
